(19) United States
(12) Patent Application Publication
(10) Pub. No.: US 2026/0335178 A1
(43) Pub. Date: Oct. 29, 2026

(54) PRESSURE WAVE MASSAGE DEVICE

(71) Applicant: EIS GmbH, Bielefeld (DE)

(72) Inventor: Thomas MILEWSKI, Werther (DE)

(73) Assignee: EIS GmbH, Bielefeld (DE)

(21) Appl. No.: 19/115,934

(22) PCT Filed: Oct. 2, 2023
(86) PCT No.: PCT/EP2023/077208

§ 371 Date: Mar. 27, 2025

(30) Foreign Application Priority Data
Oct. 1, 2022 (DE) 10 2022 125 443.7
Oct. 4, 2022 (DE) 10 2022 125 534.4
Jan. 9, 2023 (DE) 10 2023 100 342.9

(51) Int. Cl. A61H 19/00; A61H 9/00; A61H 23/04

(52) U.S. Cl. CPC A61H 19/34; A61H 9/0007; A61H 23/04; A61H 2201/1654; A61H 2201/1685; A61H 2201/169

(57) ABSTRACT

The invention relates to a pressure wave massage device for body parts, in particular erogenous zones such as the clitoris, comprising: a pressure-field generation unit (10) having a hollow chamber (12) with an output cross-sectional area (8) for placing on a body part to be stimulated and a medium-influencing assembly (18), acting on a gaseous or liquid medium or a mixture thereof in the hollow chamber, which is designed to generate a pressure field in the hollow chamber from periodically alternating underpressures and overpressures in relation to a reference pressure; a drive unit (20) which is designed to drive the medium-influencing assembly (18) in such a way that the pressure field is generated in the hollow chamber (12); and a housing (2) containing both the drive unit (20) and the pressure-field generation unit (10) with the medium-influencing assembly (18) and at least one section of the hollow chamber (12). The invention is characterised by the provision of a flexible wall section which covers the output cross-sectional area (8) and thereby closes the hollow chamber (12) and which is caused to move in a reciprocal motion with the generation of the pressure field in the hollow chamber (12) in order to mechanically act on the body part to be stimulated.

The invention relates to a pressure wave massager for parts of the body, in particular erogenous zones such as the clitoris, with a pressure field-generating device, which has a cavity with an output cross-sectional area for placing on a body part to be stimulated and a medium-influencing assembly, located in the cavity, which acts on a gaseous or liquid medium or a mixture thereof and which is designed so as to generate in the cavity a pressure field alternating between negative pressures and positive pressures relative to a reference pressure, a drive device, which is designed to drive the medium-influencing assembly in such a way that the pressure field is generated in the cavity, and a housing that jointly contains the drive device and the pressure field-generating device together with the medium-influencing assembly and at least a section of the cavity.

A device of the type mentioned above is known from, for example, EP 3 228 297A1 . This device contains a cavity that forms a single continuous chamber. The outer end of the cavity flows into an application opening, through which the chamber is connected to the ambient environment and which, in this known device, defines the output cross-sectional area to be placed on a body part to be stimulated. The term “output cross-sectional area” therefore refers to the area at which the pressure waves from the take effect on a body part that is to be stimulated. The medium-influencing assembly has a membrane that closes off the cavity at its inner end and is moved by the drive device alternately in the direction of the application opening and in the opposite direction. The reciprocal movement of the membrane causes a change in the volume of the chamber such that, at the application opening, depending on whether a closed or an open operation takes place, a pressure field of alternating minimum and maximum pressures in relation to the atmospheric norm or an air flow with alternating, oppositely oriented direction of flow, is generated.

The object of this invention is to modify a pressure wave massager of the above-mentioned type in such a way that, in comparison to conventional pressure wave massagers, a new type of stimulation is achieved.

This object is achieved by means of a pressure wave massager for body parts, in particular erogenous zones, such as the clitoris, with a pressure field-generating device, which has a cavity with an output cross-sectional area for placing on a body part to be stimulated and a medium-influencing assembly, located in the cavity, which acts on a gaseous or liquid medium or a mixture thereof and which is designed so as to generate in the cavity a pressure field alternating between negative pressures and positive pressures relative to a reference pressure, a drive device, which to drive the medium-influencing assembly in such a way that the pressure field is generated in the cavity, and a housing that jointly contains the drive device and the pressure field-generating device together with the medium-influencing assembly and at least a section of the cavity, characterized by a flexible wall section that covers the output cross-sectional area and thus closes off the cavity and which, when the pressure field is generated in the cavity, is moved in a reciprocal motion in order to mechanically act upon the body part to be stimulated.

According to the invention, the output cross-sectional area is not formed by an application opening, but covered by a flexible wall section, which thereby closes off the cavity. The pressure waves generated in the cavity by the pressure field-generating device no longer emerge from the device according to the invention, but hit the wall section closing off the output cross-sectional area. As a result, the pressure waves act on the flexible wall section and set it into a corresponding reciprocal movement. For stimulation, the oscillating flexible wall section is placed in mechanical contact with the body part to be stimulated, resulting in a mechanical impact on the body part to be stimulated with the reciprocal movements of the flexible wall section. According to the invention, the body part to be stimulated is therefore no longer impacted by pressure waves or air flows, but by the flexible wall section. While, therefore, conventional pressure wave massagers of the above-mentioned type make use of indirect stimulation, in which the body part to be stimulated is excited by pressure waves or reciprocally oscillating air flows, the solution according to the invention makes use of direct stimulation by mechanical impact on the body part to be stimulated.

A further advantage of the solution according to the invention is that liquid, in particular water, or a mixture of liquid and gas, in particular air, can also be used as a medium. Since the cavity of the flexible wall section covering the output cross-sectional area is self-contained and thus as good as hermetically sealed relative to the ambient environment, there is also no risk of leakage and thus unwanted escape of such a medium. Due to the physical circumstance that liquid is essentially an incompressible fluid, it is ensured that the pressure waves from the pressure field-generating device will strike the flexible wall section without, at least, noticeable damping and thus essentially unchanged, thereby efficiently allowing the full potential of the pressure waves to be used.

For the sake of completeness, it should be noted at this point that the cavity is in principle not subject to any spatial restrictions. For example, the cavity can be a single chamber or an arrangement of multiple chambers and/or may be bent and/or may include branches. Similarly, the position of the output cross-sectional area covered by the flexible wall section is arbitrary, and it does not necessarily have to lie at one end of the cavity, but can alternatively also be provided on one side of the cavity, provided that the flexible wall section is appropriately accessible for mechanical impact upon the body part to be stimulated.

Furthermore, for the sake of completeness, it should also be noted at this point that, for the purpose of the invention, the housing need not necessarily be formed of a single piece, but may also, for example, consist of several sections or even of housing segments that are physically separate. Alternatively, it is also conceivable for the drive device to be positioned outside the housing or in a separate housing. It is also conceivable, alternatively, to essentially only form the cavity within the housing and to arrange the other parts of the pressure field-generating device, including in particular the medium-influencing assembly and the drive device, outside the housing or in another housing.

Preferred designs and further developments of the invention are identified in the dependent claims.

In the absence of the pressure field, the flexible wall section ideally assumes ma neutral position and, when the pressure field is generated in the cavity, is set into a reciprocal movement around the neutral position relative to the cavity, in and out.

Preferably, the flexible wall section is elastic and is preferably pre-tensioned in a flat position in the style of a tensioned membrane.

A preferred design from a structural point of view is characterized by the flexible wall section is designed in the style of a membrane closing off the cavity or as such a membrane.

Preferably, the output cross-sectional area and/or the flexible wall section are essentially round.

It is advantageous not only for hygienic reasons, but also for the desired movement, if the flexible wall section can be made of flexible material, preferably a silicone material and in particular a medical-grade silicone material, or a thermoplastic elastomer (TPE) or thermoplastic polyurethane (TPU).

Preferably, the flexible wall section can have a Shore hardness in the range of Shore 5 to Shore 50.

In the case of another preferred design, the thickness or wall thickness of the flexible wall section is not less than 0.2 mm, and in particular not less than 0.4 mm, preferably not less than 0.6 mm, and/or not greater than 2 mm, in particular, not greater than 1 mm, preferably not greater than 0.8 mm. It has been found that the thinner the thickness or wall thickness, the more the stimulation effect is increased, but at the same time this not only makes the flexible wall section more unstable, but above all increases the noise level, until there is a significantly increased risk that the flexible wall section will lose its elasticity, becoming “worn out”, thus impairing its effect or even making it entirely ineffective or, in the worst case, resulting in a tear, and making the noise level annoying. Furthermore, it has been found that at thicker thicknesses or wall thicknesses, the noise level decreases, but that the flexible wall section moves more slowly, potentially also with a reduced stroke length, and thus the effect of the flexible wall section is impaired until the flexible wall section is so severely restricted in its movement that the intended effect is no longer produced.

Another preferred design is characterized by the ratio between the diameter of the output cross-sectional area and the thickness or wall thickness of the flexible wall section covering the output cross-sectional area is not less than 5, in particular not less than 10, preferably not less than 15, and/or not greater than 60, in particular not greater than 30, preferably not greater than 20. In this regard as well, it has been found that as the ratio between the diameter of the output cross-sectional are and the thickness or wall thickness of the flexible wall section increases, so the stimulation effect increases, but at the same time this not only makes the flexible wall section more unstable, but above all increases the noise level, until there is a significantly increased risk that the flexible wall section will lose its elasticity, becoming “worn out”, thus impairing its effect or even making it entirely ineffective or, in the worst case, resulting in a tear, and making the noise level annoying. Furthermore, it has been found that as the ratio decreases, so the noise level decreases, but that the flexible wall section moves more slowly, potentially also with a reduced stroke length, and thus the effect of the flexible wall section is impaired until the flexible wall section is so severely restricted in its movement that the intended effect is no longer produced. In this context, the diameter usually defines the distance between two essentially opposite side wall sections of the output cross-sectional area. If the output cross-sectional area is formed in an essentially circular shape, the usual geometrical definition applies to the diameter, according to which the diameter runs through the center point of the circle and has twice the length of the radius. If, however, the shape of the output cross-sectional area deviates from a circular shape by, in particular, being formed in an elliptical or polygonal way, then the “diameter” includes equally both the greatest distance between two opposite side wall sections and the smallest distance between two opposite side wall sections, as in for example the case of an ellipse, the distance between the main vertices along the major axis and the distance between the minor vertices along the minor axis running at right angles to the major axis.

Another preferred example design is characterized by the fact that the cavity has a first end and, opposite the first end and at a distance from it, a second end, and is bounded by a side wall that connects its two ends, in particular an essentially rigid side wall, and the first end has the output cross-sectional area, whereby, in case of a modification of this design, the output cross-sectional area is aligned at an angle or essentially transverse to a defined axis between the first and the second end.

Preferably, the medium-influencing assembly has a volume-adjustment element for changing the volume of the cavity.

A further development of the above-mentioned design is characterized by the cavity is bounded by a wall, a section of the otherwise essentially rigid wall of the cavity is movable, the volume-adjustment element has the movable section of the wall of the cavity and the drive device is designed to move this movable section of the wall of the cavity in a reciprocal motion. The above-mentioned movable section of the wall is preferably a membrane that closes off the inner end of the cavity.

In the case of a further development of the above-mentioned design, the said wall is formed from the side wall and the movable section of the wall is arranged at the second end of the cavity and the second end of the cavity preferably has an opening that is covered by the movable section of the wall and thus closed off.

An alternative further development of the above-mentioned design is characterized in that the volume-adjustment element has a piston positioned inside the cavity that moves in a reciprocal motion and the drive device is designed to move the piston in a reciprocal movement. This further development is similar in design and function to, for example, a bicycle pump or a piston motor. Preferably, the piston is movable reciprocally along one section of the cavity, whereby preferably a cross-section of the cavity defined transverse to its length is, at least along the length of that section, essentially unchanged or at least nearly the same, and the piston has a corresponding cross-section, whereby the cavity preferably has the shape of a tube at least along that section.

Preferably, the cavity forms a single continuous chamber and thereby a single-chamber arrangement.

Furthermore, preferably, the cross-sectional area of the cavity at its first end, this having the output cross-sectional area, is larger than the cross-sectional area at its inner second end, on which, preferably, the medium-influencing assembly acts. This can be used to create a kind of amplification effect during transmission of the pressure waves to the flexible wall section covering the output cross-sectional area.

An alternative design is characterized in that the cavity has a first chamber, a second chamber having the output cross-sectional area, and a connecting element connecting the first chamber to the second chamber, whereby the medium-influencing assembly is configured in such a way that it acts on the first chamber. This design thus concerns a two-chamber arrangement, whereby alternatively, in principle, arrangements with more than two chambers are possible.

preferably, the reference pressure is formed by the ambient air pressure.

For practical purposes, is advisable to design the device as a hand-held device, preferably powered by electrical batteries.

Preferably, the flexible wall section covering the output cross-sectional area can have no permanent connection to the side wall. This preferred design thus enables a removable arrangement of the flexible wall section, which allows the output cross-sectional area to be opened and the cavity behind to be made accessible, in particular for cleaning purposes.

Another preferred design is characterized by a removable and/or interchangeable applicator body, located on or in the housing, which contains a recess that forms at least one section of the cavity in the area of its output cross-sectional area. According to this design, the output cross-sectional area and thus also the flexible wall section covering it are provided on the applicator body. Since the applicator body is to be arranged such that it is removable and/or interchangeable on or in the housing, this design has the advantage, of using different designs of flexible wall sections for different applications by switching out the applicator body. Similarly, this design offers the flexibility to, instead of an applicator body with a flexible wall section covering the output cross-sectional area, as necessary use an applicator body that differs in design from the solution according to the invention and thus uses a different design element to produce stimulation.

In the case of a further development of this design, the recess is formed as an aperture in the applicator body and preferably such an applicator body as a grommet.

Not only for hygienic reasons, but also in order to achieve an optimized transmission of the pressure waves to the body part to be stimulated, the applicator body should be made of essentially flexible material, in particular silicone.

An alternative further development is characterized by the fact that at least one section of the cavity is comprehensively bounded by side wall, in particular a rigid side wall, of a sleeve forming the applicator body, preferably made of plastic, which is attached to the housing, in particular by an elastically latching form closure, and the output cross-sectional area with the flexible wall section covering it, which is preferably formed in one piece and integral with the side wall. Preferably, the wall thickness of the side wall is at least twice the wall thickness of the flexible wall section, preferably at least five times as thick, and/or the sleeve with the side wall and the flexible wall section formed as a one-piece molded part in an injection molding process.

To achieve the desired hermetic sealing of the cavity relative to the ambient environment, the cavity should preferably be sealed, whereby the cavity is not provided with any other openings and/or valves.

Another design, preferably, is characterized by a compensation device for filling and emptying the cavity with a compressible or incompressible fluid medium or a mixture thereof exhibiting a specific mix ratio, whereby the compensation device preferably has a sealable channel flowing into the cavity, which is connected to a filling opening or a pressure equalization chamber. This design offers a simple way of enabling the optional use of a gaseous or liquid medium or a mixture thereof with a specific mixing ratio for configuring the pressure wave massage device with a desired maximum displacement of the flexible wall section covering the output cross-sectional area and the resulting stimulation intensity.

According to a second aspect of the invention, an applicator body is proposed for a pressure wave massager, whereby the applicator body is arranged to be removable on or in the housing of the pressure wave massager and contains a recess provided for receiving a gaseous or liquid medium or a mixture thereof with an output cross-sectional area for applying to a body part to be stimulated, characterized by a flexible wall section that covers the output cross-sectional area and thereby closes off the recess and which, when a pressure field is generated, alternating between negative pressures and positive pressures relative to a reference pressure in the medium located in the recess, is set into a reciprocal motion for mechanical impact on the body part to be stimulated.

According to a third aspect of the invention, a modular system is proposed for constructing a pressure wave massager for the stimulation of body parts, in particular erogenous zones such as the clitoris, with a pressure field-generating device that has a cavity with an output cross-sectional area for placing on a body part to be stimulated and a medium-influencing assembly for acting upon a gaseous or liquid medium or a mixture therefore in the cavity, which is designed in order to generate, in the cavity, a pressure field consisting of alternating negative pressures and positive pressures relative to a reference pressure, a drive device that is designed to drive the medium-influencing assembly in such a way that the pressure field is generated in the cavity, and a housing that jointly contains the drive device and the pressure field-generating device together with the medium-influencing assembly and with at least one section of the cavity, as well as, located on or in the housing, a removable and/or interchangeable applicator body of the first kind, which contains a recess that forms at least a section of the cavity in the area of its output cross-sectional area, which is designed as an application opening, for indirect stimulation of body parts by means of pressure waves, characterized by, in place of the applicator body of the first kind, on or in the housing, a removable and/or interchangeable applicator body of a second kind, containing a recess forming at least a section of the cavity in the area of its output cross-sectional area, which is covered by a flexible wall section and thereby closed off, whereby the flexible wall section, when the pressure field is generated in the cavity, is set into a reciprocal motion for mechanical impact upon the body part to be stimulated for direct stimulation of that body part.

The above-mentioned objective is also achieved according to a fourth aspect of the invention, by the use of a pressure wave massage device originally intended for indirect stimulation of body parts, in particular erogenous zones such as the clitoris, by means of pressure waves with a pressure field-generating device that has
a cavity with an application opening for applying to a body part to be stimulated and a medium-influencing assembly that acts upon a gaseous or liquid medium or a mixture thereof located in the cavity, which is designed so as to generate in the cavity a pressure field alternating between negative pressures and positive pressures relative to a reference pressure
a drive device that is designed to drive the medium-influencing assembly in such a way that the pressure field is generated in the cavity, and
a housing that jointly contains the drive device and the pressure field-generating device together with the medium-influencing assembly and with at least one section of the cavity,
for direct stimulation of a body part to be stimulated, whereby
the application opening is covered by a flexible wall section and thereby closed off, which, when the pressure field is generated in the cavity, is set into a reciprocal motion for mechanical impact upon the body part to be stimulated.

Below, example designs from the state of the art are initially presented as comparative examples and then preferred design forms of the invention are explained in greater detail using the enclosed drawings. These show:

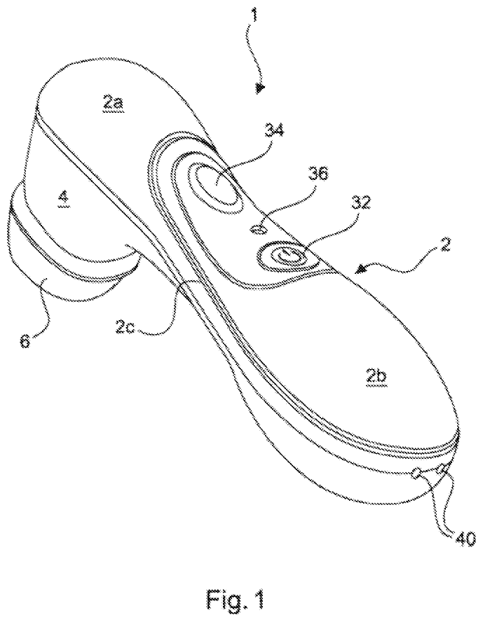

FIG. 1 A perspective side view of a known state-of-the-art pressure wave massager according to a first example design;

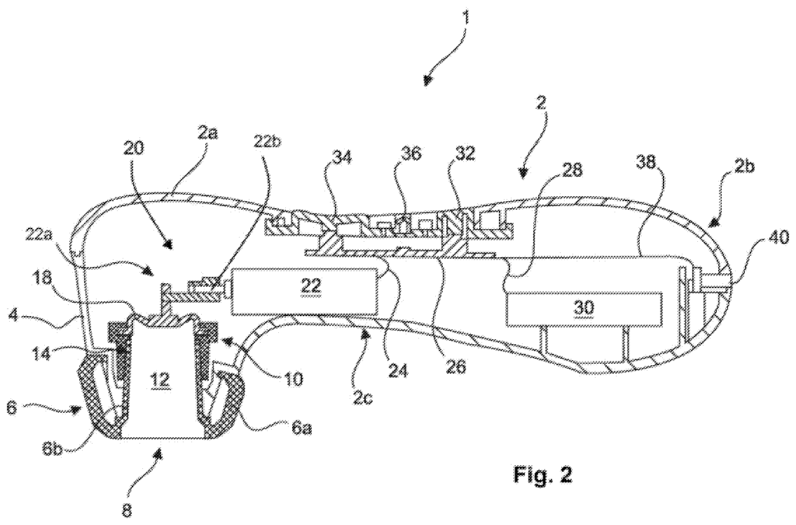

FIG. 2 A longitudinal section through the pressure wave massager in FIG. 1;

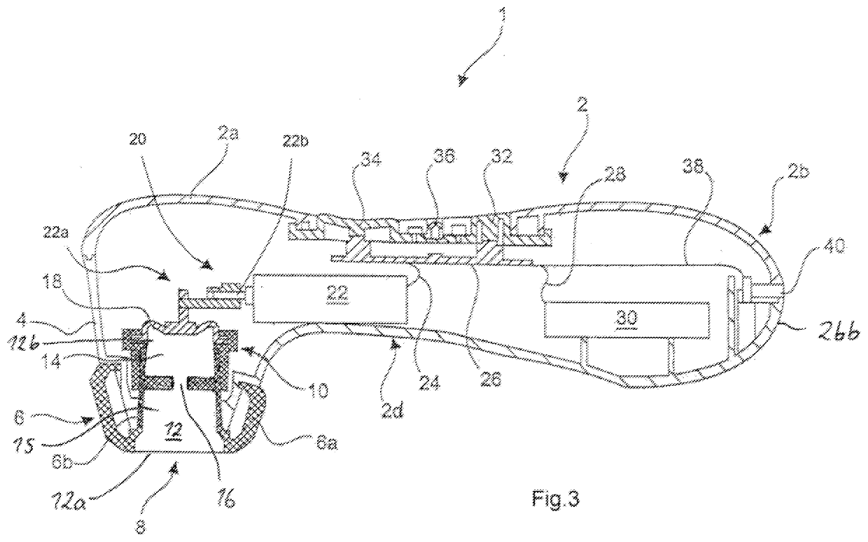

FIG. 3 A longitudinal section through a known state-of-the-art pressure wave massager according to a second example design;

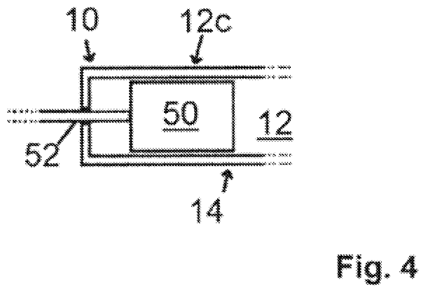

FIG. 4 A schematic longitudinal representation of an enlarged view of a part of a pressure field-generating device and the cavity of a known state-of-the-art pressure wave massager according to a third example design;

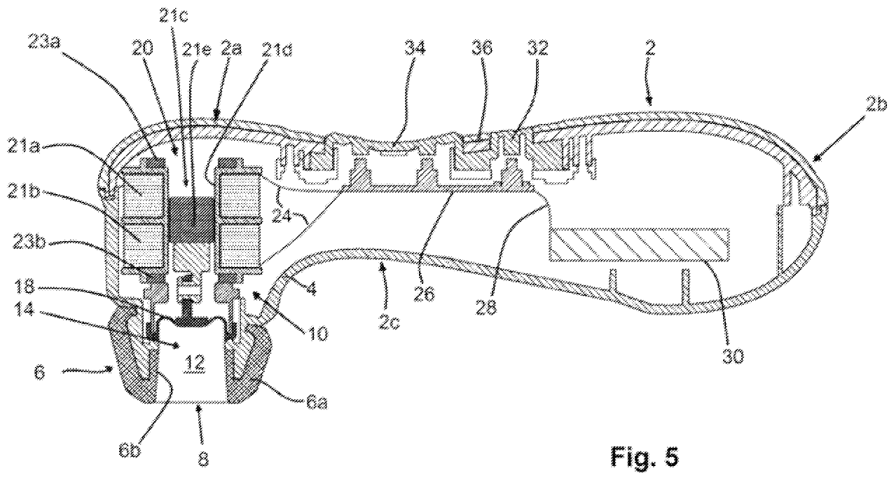

FIG. 5 A longitudinal section through a known state-of-the-art pressure wave massager according to a fourth example design;

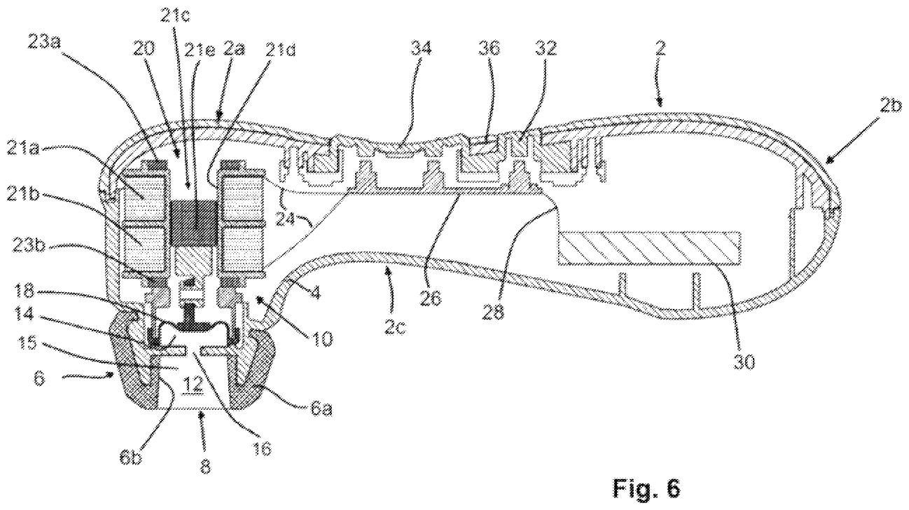

FIG. 6 A longitudinal section through a known state-of-the-art pressure wave massager according to a fifth example design;

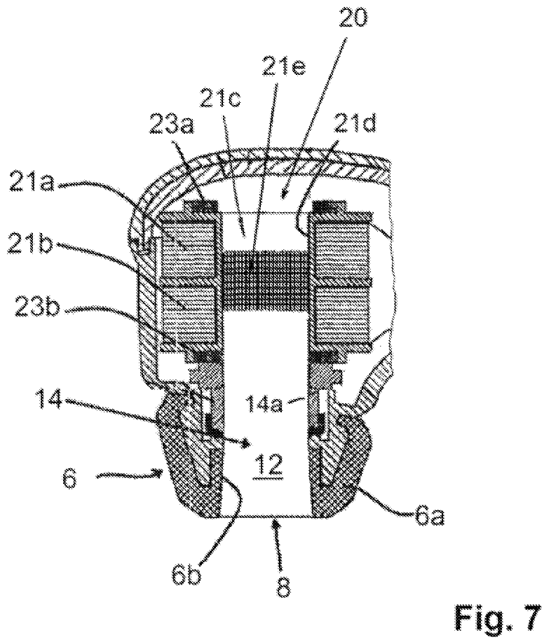

FIG. 7 A schematic longitudinal representation of a single view of an assembly formed by the drive device and the cavity of a known state-of-the-art pressure wave massager according to a sixth example design;

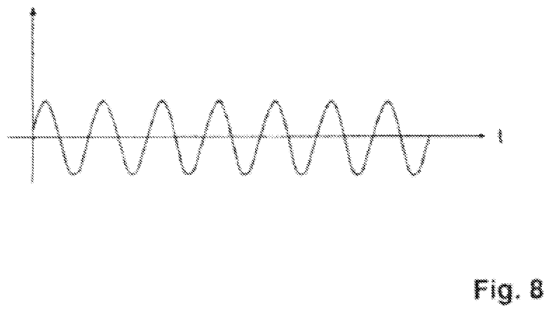

FIG. 8 A depiction of the course of the pressure waves generated by a known state-of-the-art pressure wave massager according to FIGS. 1 to 7 in a medium such as, in particular, air;

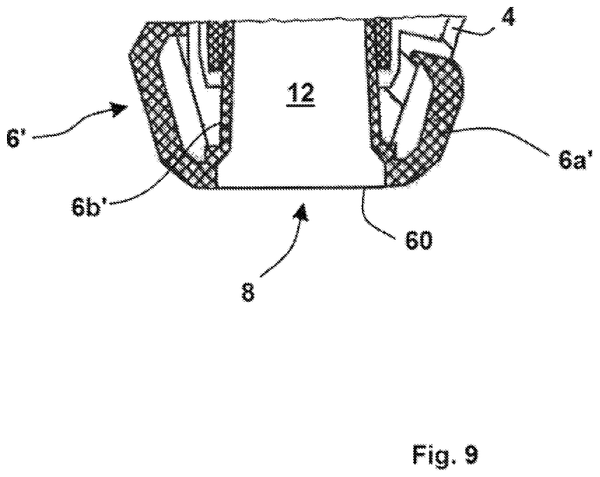

FIG. 9 A schematic longitudinal representation of an enlarged view of an extension and a grommet attached to it with a membrane closing off one of its openings and depicted in a neutral position in a pressure wave massager according to a preferred first design of the invention;

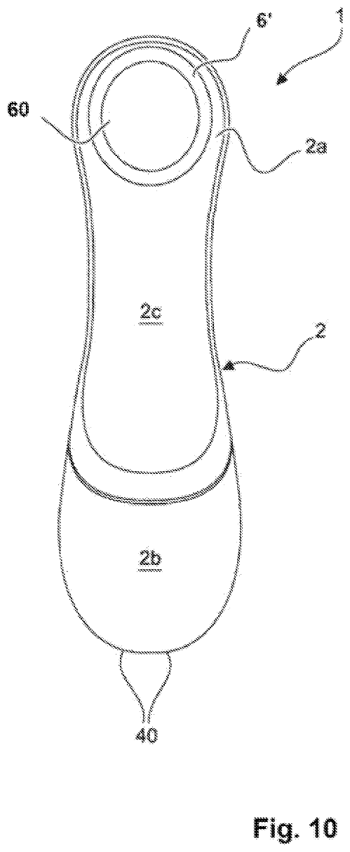

FIG. 10 A front view of the preferred first design of the invention;

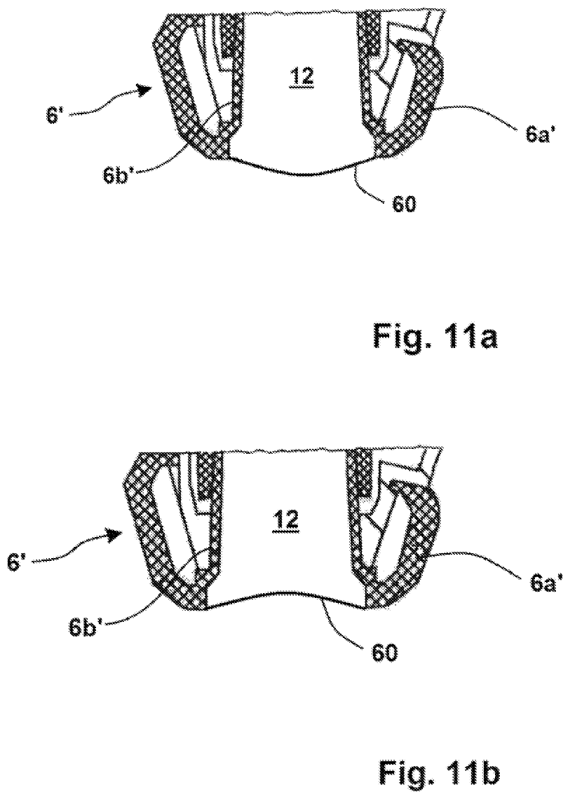

FIG. 11 The same view as FIG. 9 with the membrane in a maximally outward-deflected position (a) and in a maximally inward-deflected deflected position (b);

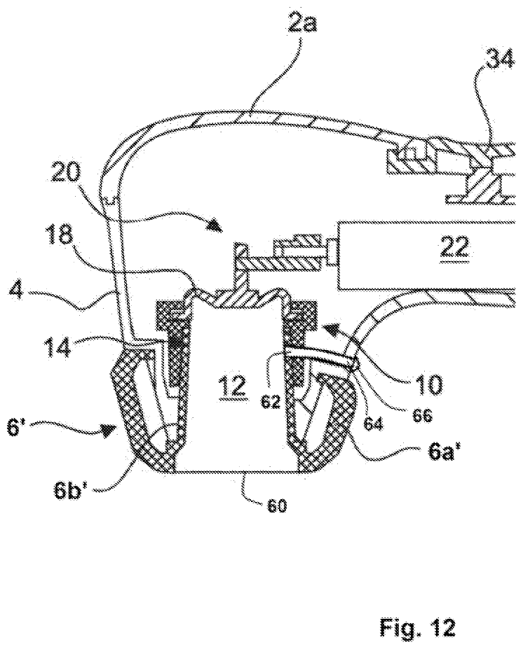

FIG. 12 A schematic longitudinal representation of an enlarged view of the head area of a pressure wave massager in accordance with a second preferred design of the invention; and

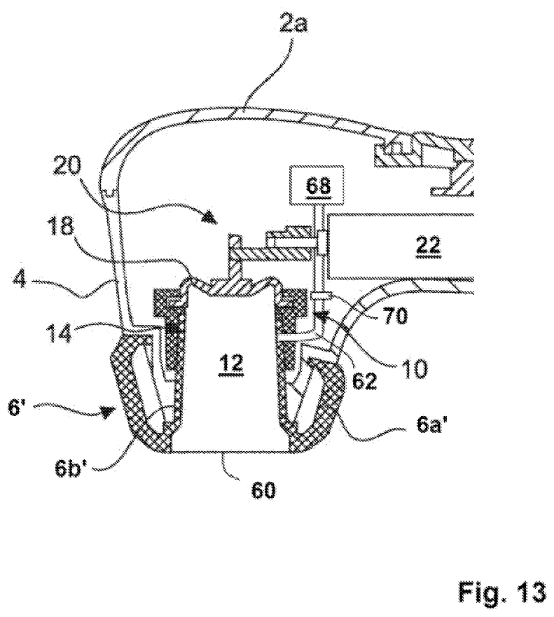

FIG. 13 A schematic longitudinal representation of an enlarged view of the head area of a pressure wave massager in accordance with a third preferred design of the invention.

The pressure wave massager 1 shown in FIGS. 1 and 2 as a first example design known from the state of the art exhibits an elongated housing 2 with a first end section 2a, a second opposing end section 2b and an intermediate middle section 2c. Preferably, the housing is made of plastic. As can be seen from FIGS. 1 and 2, the two end sections 2a and 2b are rounded and taper slightly toward the middle section 2c, which is a little slimmer.

At the first end section 2a of the housing 2, an extension 4 is formed, projecting transversely to the longitudinal extension of the housing 2 and forming together with the first end section 2a of the housing 2, a head of the pressure wave massager 1, while the second end section 2b of the housing 2 preferably acts as a handle to hold the pressure wave massager 1 during the application which is to be described in greater detail below.

As FIGS. 1 and 2 in particular further show, there is located on the extension 4 a grommet 6, which contains an application opening, which can be seen in FIG. 2 and is marked with the reference number “8”. Preferably, the grommet 6 consists of a soft or flexible plastic material such as, in particular, a silicone material.

In the head of the pressure wave massager 1 formed by the first end section 2a of the housing 2 and the extension 4, there is housed a pressure wave-generating device 10, with the help of which a stimulating pressure field or a stimulating reciprocal air flow is generated in the application opening 8. As can be seen in detail in FIG. 2, the pressure field-generating device 10 has a cavity 12 with an outer first end, which simultaneously also forms the application opening 8 in the grommet 6, and an internal second end that is opposite to and at a distance from the first end. In the first example design shown, the cavity 12 is formed by a single continuous chamber 14 and bounded by an inner or side wall, preferably essentially rigid, connecting its two ends. As FIG. 2 further shows, the grommet 6 has an outer section 6a, with which it is attached to the extension 4 such that it can be detached, and an inner section 6b, whereby the outer section 6a and the inner section 6b of the grommet 6 are connected to one another in the area of the application opening 8. The inner section 6b of the grommet 6 is shaped like a sleeve and bounds an outer section of the cavity 12 leading to its outer first end. The application opening 8 forms a level that, in the presented example design, is essentially aligned transversely to the longitudinal axis of the cavity 12, whereby the alignment is in principle alternatively can also be oriented at a different angle compared to the longitudinal axis of the cavity 12.

As FIG. 2 further shows, according to the first example design, the cavity 12 is free of discontinuity points, whereby the cross-section of the cavity 12 perpendicular to its length L between its two ends in the presented example design essentially almost constant over the entire length L between its two ends are almost constant and expands only slightly toward the application opening 8, so that the opening cross-section of the application opening 8 also corresponds approximately to the cross-section of the cavity 12. The cavity 12 preferably essentially has the shape of a rotational body with a circular or elliptical cross-section; alternatively it is also conceivable for the cavity 12 to exhibit a polygonal, preferably square or hexagonal, cross-section. The chamber 14 thus forms a continuous tube with an approximately constant cross-section over its entire length, whereby in the presented example design, the cavity is oriented along its length L approximately transversely to the longitudinal extension of the housing 2.

Furthermore, the cavity 12 is, at its inner second end, closed off with a flexible membrane 18, preferably of silicone, which extends over the entire cross-section of the cavity 12 and is driven by a drive device 20. The drive device 20 has, in the presented example design, a drive motor 22 as a rotary motor and a mechanism 22a. The mechanism 22a is designed such that the turning movement of the output shaft 22b of the drive motor 22 is converted into a reciprocal longitudinal motion, whereby the membrane 18 is set into a motion perpendicular to the plane it spans, alternating in the direction of the application opening 8 and in the opposite direction. This changes the volume of the cavity 12 of the chamber 14 as a function of the rotation of the output shaft of drive motor 22. Preferably, the mechanism 22a has an eccentric or a connecting rod with which to convert the rotary movement of the output shaft 22b of the drive motor 22 into a reciprocal longitudinal movement for the reciprocal displacement of the membrane 18. The reciprocal movement of the membrane 18 effects a change, in accordance with its stroke (amplitude), in the volume of the cavity 12 between a minimum volume and a maximum volume, whereby the change occurs repeatedly at a frequency.

As FIG. 2 further shows, the drive motor 22, which contains, in the described example design, an electric motor, is connected via an electrical cable 24 to an electronic control circuit board 26, which controls the drive motor 22. The control circuit board 26 is connected via an electrical cable 28 to a battery 30, which provides the drive motor 22 and the control circuit board 26 with the necessary electrical power. The battery 30 can optionally be a non-rechargeable battery or a rechargeable battery.

While the presented example design shows the drive motor 22 in the connection area between the slim middle section 2c of the housing 2 and the first end section 2a of the housing 2 and thus adjacent to the head of the pressure wave massager 1 formed of the first end section 2a of the housing 2 and the extension 4, the battery 30 is arranged in the second end section 2b of the housing 2, which means that the housing 2 is well balanced when the pressure wave massager 1 is held in the hands of the user.

As FIGS. 1 and 2 further show, a power button 32 is provided, which can be used to switch the pressure wave massager 1 on and off from the outside of the housing 2 and is located in the slim middle section 2c of the housing 2. Also in the slim middle section 2c of the housing 2 is a button 34 to be operated from the outside, with which various operating modes of the pressure wave massager 1 can be adjusted, as well as a indicator light 36, preferably formed from an LED and visible from the outside The power button 32 and the button 34 are arranged directly on the control circuit board on the underside of the wall of the housing 2, while the indicator light 36 is connected to the control circuit board 26 via an electrical cable not shown in the figures.

In addition to controlling the drive motor 22, in the presented example design, the electronic control circuit board 26 also controls charge management of the battery 30. For this purpose, the control circuit board 26 is connected via an electrical cable 38 to the charging contacts 40, which are on the front side of the second end section 2b of the housing 2 and are externally accessible, as can be seen in FIGS. 1 and 2. An external battery charger not shown in the figures can be connected to these charging contacts 40 via a plug with magnetic plug contacts, which in order to establish an electrical connection via magnetic forces, can be brought into contact with the charging contacts 40.

The described pressure wave massager 1 is designed as a hand-held device and for use with the grommet 6, is placed upon a body part to be stimulated, not shown in the figures, in such a way that it is essentially enclosed by the grommet 6 in the area of the application opening 8. While the pressure wave massager 1 is in operation, the body part to be stimulated is then, via the reciprocal motion of the membrane 18, subjected to alternating different air pressures or a reciprocal air flow.

The control circuit board 26 preferably has a memory, not shown in the figures, in which various modulation patterns are stored. By operating the button 34 accordingly, a desired modulation pattern can be selected, in order to then drive motor 22 accordingly.

FIG. 3 shows a longitudinal section of a known state-of-the-art pressure wave massager according to a second example design. While the previously described example design has a so-called 1-chamber arrangement, the second example design makes use of a 2-chamber arrangement. With the exception of the thereby different design of the cavity 12, the second example design does not differ from the first example design, so that the same components are marked with the same reference numbers and, in order to avoid repetition, reference is made to the previous description of the first example design.

As can be seen in FIG. 3, the cavity 12 is accordingly formed not only by a first chamber 14, but also a second chamber 15 and a connecting channel 16 connecting the two chambers 14, 15, such that the channel 16 takes on the role of a connecting element between the two chambers 14, 15. Here, the first chamber 14 is an inner chamber and the second chamber 15 is an outer chamber. The outer second chamber 15 ends at the outer first end 12a of the cavity 12 and therefore at the application opening 8, which thus forms the outer end of the second chamber 15. The first chamber 14 ends inside the stimulation device 1 at the inner end 12b of the cavity 12, which thus also forms the inner end of the first chamber 14.

In the presented example design, the channel 16 forms a discontinuity point relative to the two chambers 14, 15. Accordingly, the cross-sectional area of the channel 16 at its opening into the first chamber 14, which is not shown in greater detail in FIG. 3, is only a fraction of the cross-sectional area of the first end of the first chamber 14 located adjacent to the channel 16. Similarly, the cross-sectional area of the channel 16 at its opening into the second chamber 15, which is likewise not shown in greater detail in FIG. 3, is a fraction of the cross-sectional area of the second end of the second chamber 15 located adjacent to the channel 16.

In the presented example design, the channel 16 has, over its entire length between the two chambers 14, 15 essentially constant cross-sectional area, although it is also conceivable in principle for the channel 16 to have a cross-sectional area that changes over its length.

Similarly, in presented example design, the channel 16 is designed to be straight and rigid, with the opening of channel 16 into the second chamber 15 located opposite the application opening 8 and the channel 16 oriented toward the application opening 8.

As FIG. 3 further shows, the cavity 12 is closed off at its inner end 12b, and thereby the inner first chamber 14 at its inner end as in the first example design, with the flexible membrane 18, which extends over the entire cross-section of the inner second end 12b of the cavity 12 and thereby over the inner end of the inner first chamber 14 and is driven by the mechanism 22a of the drive motor 22. The reciprocal movement of the membrane 18 changes the volume of the first chamber 14 such that, via channel 16 in the second chamber 15 and thus at the application opening 8, a pressure field consisting of alternating maximum and minimum pressures or a reciprocal air flow is generated, whereby the channel 16 exerts a nozzle effect on the application opening 8 and thus on the body part to be stimulated.

FIG. 4 shows a schematic longitudinal section of the cavity of a known state-of-the-art pressure wave massager according to a third example design, which differs from the two example designs described above in that, instead of a flexible membrane that closes off the inner end of the chamber 14, a piston 50 is arranged in the cavity 12 in a reciprocally movable manner, while the other components are realized in the same manner as for the first or second example designs, so that, in order to avoid repetition, reference is made to the previous description. The piston 50 is set into motion by the drive motor 22 via the mechanism 22a (similar to the flexible membrane 18 in the first or second example designs) in a reciprocal movement along a section 12c of the cavity 12. The cross-sectional area of the cavity 12 defined transversely to its length is thereby, in terms of its size and shape, essentially unchanged or at least almost constant over the length of that section 12c and the piston 50 has a corresponding cross-sectional area. To that end, in the presented example design, that section 12c of the cavity 12 is in the shape of a tube. The third example design is similar to, in terms of design and function, a bicycle pump or a piston motor, for example. The reciprocal movement of the piston 50 generates at the application opening a pressure field with correspondingly varying pressures or a reciprocal air flow.

FIG. 5 shows a longitudinal section of a known state-of-the-art pressure wave massager according to a fourth example design, which differs from the first example design according to FIG. 2 in the design of the drive device 20 described in greater detail below. With the exception of the different design of the drive device 20, the fourth example design does not differ from the first example design, so that the same components are marked with the same reference numbers and in order to avoid repetition, reference is made to the previous description of the first example design.

In the fourth example design shown in FIG. 5, the drive device 20 specifically is designed as an electromagnetically operated linear drive. To that end, the drive device 20 in the presented example design has two stationary magnetic coil elements 21a, 21b, each designed as cylindrical coils and arranged in a coaxial direction, one behind the other. The arrangement of the two stationary electromagnetic coil elements 21a, 21b contains a central cavity 21c, open at both ends, which is enclosed and thus bounded by a circumferential internal wall 21d.

The cavity 21c enclosed by the inner wall 21d has, in the presented example design, the shape of a tube, which is preferably formed as a cylinder. Within the cavity 21c is a coaxially oriented magnetic or magnetizable core 21e arranged in a reciprocally movable arrangement. The cross-sectional area of this cavity 21c defined transversely to its length is thereby, in terms of its size and shape, essentially unchanged or at least almost constant and the core 21e has a corresponding cross-sectional area.

The core 21e, in turn, is coupled to the membrane 18. In FIG. 5, the core 21e and the membrane 18 are in the middle position. The two stationary electromagnetic coil elements 21a, 21b are activated and excited in such a way that the core 21e arranged within the arrangement of the two stationary electromagnetic coil elements 21a, 21b, is set into a reciprocal motion, which is transferred to the membrane 18 accordingly. As FIG. 5 further shows, the stationary electromagnetic coil elements 21a, 21b are connected to the control circuit board 26 via the electrical cables 24, which correspondingly control and excite the stationary electromagnetic coil elements 21a, 21b. In the presented example design, the core 21e is not equipped with an electromagnetic coil, but rather consists of a solid body made of magnetic or magnetizable material, such as rare earth elements.

In order to limit the stroke of the reciprocally moving core 21e, both ends of the arrangement of the stationary electromagnetic coil elements 21a, 21b are equipped with end magnets 23a, 23b. The ends of the core 21e and of the end magnets 23a, 23b facing each other have the same magnetic polarity. This results in the core 21e being subjected to a repulsive force generated by the end magnets 23a, 23b, which increases with increasing proximity to the core 21e. As a result, the core 21e of the electromagnets 23a, 23b is decelerated until it is subjected to an opposite movement. The end magnets 23a, 23b thus act as magnetic impact elements. Alternatively, it is also conceivable for mechanical impact elements to be provided that are designed as stops which the core 21e comes into contact with and is thereby stopped in its further movement.

FIG. 6 shows a longitudinal section of a known state-of-the-art pressure wave massager according to a fifth example design. While the fourth example design described above is a so-called 1-chamber arrangement, the fifth example design makes use of a 2-chamber design, and indeed in the same way as the second example design according to FIG. 3. In FIG. 6, the same components are therefore identified with the same reference numbers as in FIGS. 2 and 5, and in order to avoid repetition, reference is made to the previous description of the second and fourth example designs.

FIG. 7 shows a schematic longitudinal single view of one of the assemblies jointly formed by the drive device 20 and the cavity 12 in a known state-of-the-art pressure wave massager according to a sixth example design described above, which differs from the above-described fourth example design according to FIG. 5 in that, instead of a flexible membrane that closes off the inner end of the chamber 14, the reciprocally moved core 21e of the drive device 20 itself changes the volume of the chamber 14 formed by the cavity 12, while the other components are realized in the same way as in the fourth example design, such that in order to avoid repetition, reference is made to the previous description of the fourth example design according to FIG. 5. As FIG. 7 further shows, the inner wall 21d, which, in the area of the arrangement of the two stationary electromagnetic coil elements 21a, 21b, encloses the cavity 21c that is formed in the middle there and which contains the core 21e, is flush with the inner wall 14a of the chamber 14 formed by the cavity 12. The cavity 21c which contains the core 21e and the cavity 12 therefore form a structural unit. This sixth example design, like the third example design, is similar in terms of its design and function to, for example, a bicycle pump or a piston motor. The reciprocal movement of the core 21e thereby generates at the application opening 8 a pressure field with correspondingly varying pressures or a reciprocal air flow.

In addition, it should be noted in this regard that, as a further modification, the 2-chamber arrangement according to the fifth example design shown in FIG. 6 can be applied to the design of the cavity 12 in the sixth example design shown in FIG. 7, since in that example design the cavity 12 does not consist of a single chamber but rather, according to the fifth example design, is formed of a first chamber, a second chamber and a channel connecting the two chambers. One such other example design is, however, not shown in the figures.

In addition, other drive types are also conceivable in principle that would effect a displacement of the flexible membrane 18 according to FIGS. 2, 3, 5 and 6 or of the piston 50 according to FIG. 4 in order to change the volume of the cavity 12.

This can also be achieved piezoelectrically, pneumatically or hydraulically, for example.

Finally, when it comes to changing the volume of the cavity 12, there are also other conceivable design solutions, such as, instead of a membrane, designing the side wall of the cavity 12 to be flexible in at least some sections and by applying external pressure to, at least at that point, alternately compress and decompress the cavity. This alternative solution is also not shown in the figures.

In use, a distinction is made in particular between sealed operation and open operation, which generally applies to a known state-of-the-art pressure wave massager of the type in question here and thus applies equally to the above-described example designs.

In sealed operation, the grommet 6 is applied to the body part to be stimulated such that there is no exchange of air with the ambient environment. In this operating mode, the movement of the membrane 18 according to FIGS. 2, 3, 5 and 6, of the piston 50 according to FIG. 4 and of the core 21e according to FIG. 7 generates changing pressure waves over time, preferably periodically, throughout the entire cavity 12. The pressure waves are essentially isotropic and thus also impact the first body part to be stimulated. In this case, there is essentially no air flow.

Open operation is characterized by the fact that there is an exchange of air with the ambient environment. In this operating mode, the grommet 6 is applied to the body part to be stimulated in such a way that the application opening 8 only partially encloses the body part to be stimulated and at least one slot-shaped gap between at least one section of the application opening 8 and at least one section of the body part to be stimulated remains free, thereby allowing air to escape from the cavity 12 into the ambient environment. Similarly, in this operating mode, air is drawn from the ambient environment into the cavity 12, such that there is a regular exchange of air in this case.

The pressure waves generated at the application opening 8, which form a pressure field of alternating minimum pressures and maximum pressures relative to a reference pressure, preferably air pressure, or the reciprocal air flow generated at the application opening 8, follow a wave-shaped course, which ideally corresponds to a sine curve, as shown in FIG. 8. The wave-shaped course is characterized by an amplitude that is determined by the stroke length of the flexible membrane 18 according to FIGS. 2, 3, 5 and 6, of the piston 50 according to FIG. 4 and of the core 21 e according to FIG. 7, as well as by a frequency determined by the rate of change of the reciprocal movement of the flexible membrane 18 according to FIGS. 2, 3, 5 and 6, of the piston 50 according to FIG. 4 and of the core 21e according to FIG. 7.

The known state-of-the-art pressure wave massagers, which have previously been described on the basis of various example designs, fall into the category of indirectly acting stimulation devices. With indirect stimulation, body parts to be stimulated are excited without any direct contact, but rather using the above-mentioned pressure waves (in sealed mode) or reciprocal oscillating air flows (in open mode) at the application opening 8.

In contrast, the pressure wave massager according to the invention is sealed at its application opening 8 with a so-called application membrane 60, as shown schematically in FIGS. 9 and 10. For this purpose, the example designs shown in FIGS. 9 to 13 use a grommet 6′ which differs from the grommet 6 of the previously described conventional pressure wave massagers in that the application opening 8, into which the outer section of the cavity 12 flows and thereby the outer section of the cavity 12 is closed off by the application membrane 60, but which otherwise has the same or a similar structure as the grommet 6 of the previously described conventional pressure wave massagers. Conversely, the other components are identical to those used in the known state-of-the-art pressure wave massagers according to the example designs previously described using FIGS. 1 to 8, such that in order to avoid repetition, reference is made to the previous description of the example designs pursuant to FIGS. 1 to 8.

In the design version according to the invention shown in FIGS. 9 and 10, the cavity 12 is made self-contained by the application membrane 60 and is therefore essentially hermetically sealed relative to the ambient environment. This means that the pressure field-generating device can only be used in the sealed operating mode, whereby throughout the entire cavity, only pressure waves changing over time, preferably periodically, occur in the medium contained in the cavity 12, which are essentially isotropic. As regards the medium, any type of compressible or incompressible fluid may be used, which can thus be either gaseous or liquid or a mixture of a gas, preferably air, and a liquid, preferably water. As the cavity 12 is self-contained, there is the option, in contrast to the known state-of-the-art pressure wave massagers, of using as the medium, in particular, a liquid or a mixture of liquid and a gas.

The pressure waves impact the application membrane 60 and set it into an oscillating motion, which thereby follows the wave-shaped course shown in FIG. 8 corresponding to the pressure waves. As a result, the application membrane oscillates around a neutral position, in which it is shown in FIG. 9, between the position shown in FIG. 11a that is maximally deflected to the exterior, which can be termed the maximum positive pressure displacement, and that shown in FIG. 11b that is maximally deflected to the interior, which can be termed the maximum negative pressure displacement. Accordingly, in the positive pressure phases, the application membrane 60 is pushed outwards to its maximum positive pressure displacement as per FIG. 11a and in the negative pressure phases it is pushed inwards to its maximum negative pressure displacement as per FIG. 11b.

According to the invention, the body parts to be stimulated are no longer impacted by pressure waves or air flows-as these are ‘sealed off’ by the application membrane 60—but instead by the application membrane 60. Instead of an indirect stimulation as with known state-of-the-art pressure wave massagers, direct stimulation now takes place through direct mechanical impact of the body parts to be stimulated by the oscillating application membrane 60.

The area of the cavity 12 acting on the body part to be stimulated is also referred to as the output cross-sectional area. While this output cross-sectional area is defined, in pressure wave massage devices that are known from state-of-the-art and designed for indirect stimulation, by the application opening 8 through which pressure waves or air flows pass, in the pressure wave massager designed according to the invention per FIGS. 9 to 11, the output cross-sectional area is covered and/or formed by the application membrane 60, and the application membrane 60 thereby closes off an opening that, in known state-of-the-art pressure wave massagers, in particular as they have been previously described using various example designs, is provided as an application opening 8.

In the example design shown, the application membrane 60 is elastic and, in the neutral position shown in FIG. 9, pre-tensioned in a flat position. Furthermore, in the presented example design according to FIG. 10, the application membrane 60 has a substantially round shape, defined by the grommet 6 and its original application opening 8.

The application membrane 60 is ideally made of silicone material, ideally medical grade, or a thermoplastic elastomer (TPE) or thermoplastic polyurethane (TPU). Preferably, the thickness or wall thickness of the application membrane 60 not less than 0.2 mm, in particular not less than 0.4 mm, preferably not less than 0.6 mm, and/or not greater than 2 mm, in particular not greater than 1 mm, preferably not greater than 0.8 mm whereby in a particularly advantageous design the thickness or wall thickness of the application membrane 60 can be approximately 0.6 mm. Furthermore, the application opening 8 closed off by the application membrane 60 preferably has a round shape, in particular an essentially circular shape, and its diameter preferably lies in a range between 8 mm and 14 mm, preferably between 10 mm and 12 mm. The ratio between the diameter of the application opening 8 and the wall thickness of the application membrane 60 covering and closing off the application opening 8 is preferably not less than 5 and/or not greater than 60, preferably not less than 10 and/or not greater than 30, in particular not less than 15 and/or not greater than 20.

In addition, in the presented example design, the application membrane 60 is formed in one piece with the grommet 6′, which is thus provided as an applicator body.

If the grommet 6′ is designed such that it can be attached to the extension 4, this design has the advantage of optionally using a conventional grommet 6 with open application opening 8 or a grommet 6′ according to the invention with the application membrane 60 closing off the application opening 8. The known state-of-the-art pressure wave massagers, in particular as they have been described previously using various example designs, can be used either in the conventional way for indirect stimulation or in a manner according to the invention for direct stimulation. This opens up the further advantageous option of offering such known state-of-the-art pressure wave massagers in a ‘package’ with a conventional grommet 6 and a grommet 6′ according to the invention. Accordingly, it is possible, with the presented example designs in particular, using one and the same housing 2, which indeed makes up the vast majority of pressure wave massagers, to implement either indirect stimulation by means of pressure waves or reciprocally oscillating air flows or, alternatively, direct stimulation by means of direct mechanical impact on the body part to be stimulated, simply by selecting the appropriate grommet or switching out the appropriate grommet. For indirect stimulation by application of pressure waves or reciprocal oscillating air flows, the grommet 6 with the open application opening 8 is therefore used, while for direct stimulation by direct mechanical impact on the body part to be stimulated, the grommet 6′ with the application membrane 60 closing off the original application opening 8 is used. In this way, a modular system for constructing a pressure wave massager can be achieved, which, in addition to the housing 2, which, including in particular the pressure field-generating device 10, the drive device 20, the control circuit board 26 and the battery 30, contains almost all the components and thus makes up a large majority of the pressure wave massager, includes both a grommet 6 for indirect stimulation and a grommet 6′ for direct stimulation. Since, changing between indirect stimulation and direct stimulation requires only that the grommet be switched out, this modular system offers the advantage of being able to market the pressure wave massager with two different grommets 6 and 6′ as a set.

Of course, a grommet 6′ according to the invention that is fitted with the application membrane 60 can also be provided as a replacement part for replacing a conventional grommet 6 with open application opening 8 on a known state-of-the-art pressure wave massager.

Instead of a 6′ grommet, it is also conceivable to provide, for example, a sleeve, preferably formed of a plastic, with side wall, in particular a rigid one, that circumferentially bounds at least one section of the cavity 12.

Such a sleeve is connected, such that it is detachable, to the housing 2, in particular by an elastically latching form closure, and has an output cross-sectional area that is covered by an application membrane of the type previously described, which is preferably formed in one piece and integral with the side wall. Ideally, the wall thickness of the side wall should be at least twice, preferably at least five times, as thick as the wall thickness of the application membrane. In addition, the sleeve with the side wall and the application membrane 60 can preferably be formed as a one-piece molded part in an injection molding process. For the sake of completeness, it should be noted at this point that this alternative design is not shown in the figures, whereby the above-mentioned sleeve forms a so-called applicator body in the same way as the grommet described above.

If the medium located in the cavity 12 is a gas-in particular air, as is usually the case with known state-of-the-art pressure wave massagers-then, due to the compressibility of such a medium, it may occur that the amplitude of the pressure waves is reduced on the way to the application membrane 60. As a result, the amplitude of the displacement of the application membrane 60 compared to that of the pressure field-generating device 10, which is generated, for example, by the stroke length of the flexible membrane 18 according to FIGS. 2, 3, 5 and 6, of the piston 50 according to FIG. 4 and of the core 21e according to FIG. 7, is reduced. Conversely, this phenomenon does not occur when using a liquid medium such as water, as this is an essentially incompressible fluid, which transmits the pressure waves to the application membrane 60 without, at least, a noticeable damping of the amplitude.

The optional use of a gaseous or liquid medium or a mixture of the two with a specific mixing ratio can be easily used to configure the pressure wave massager with a desired maximum displacement of the application membrane 60 and the resulting stimulation intensity. To do this, a compensation device can be used, as in, for example, the example design for the invention shown in FIG. 12, which otherwise corresponds to the design of the first example design previously described using FIG. 2. In this case, the compensation device is formed by a channel 62, which communicates with the cavity 12 and ends in a filling opening 64 in the side wall of the housing 2, where it is sealable from the outside using a locking element 66. In order to fill the cavity 12 with a medium of the desired consistency, as previously mentioned, through the filling opening 64 and the channel 62, the locking element 66 is opened. Conversely, for operation, the filling opening 64 remains sealed by the locking element 66 in order to prevent accidental escape of the medium from the cavity 12 through the channel 62.

In the further example design of the invention shown in FIG. 13, which also otherwise corresponds to the design of the first example design previously described using FIG. 2, a compensation device is likewise provided, which also has channel 62 that flows into the cavity 12. In this case, however, the channel 62 forms a connection with a pressure compensation chamber 68 located inside the housing 2. For this design, the principle of pressure compensation is therefore applied, as is also familiar from heating systems. As FIG. 13 further shows schematically, there is a valve 70 in the channel 62 through which channel 62 can optionally be fully opened or closed or partially opened, in order to thereby precisely influence the amplitude of the pressure waves.

In this context, we would like to add for the sake of completeness that, of course, the designs according to FIGS. 12 and 13 could also be implemented in pressure wave massagers according to the example designs previously described using FIGS. 3 to 7.

Otherwise, the cavity 12 remains closed relative to the ambient environment, such that there are no other valves or openings. This also applies to the designs shown in FIGS. 12 and 13, since in operation, in the design according to FIG. 12, the channel 62 is sealed by the locking element 66 and, in the design according to FIG. 13, the cavity 12 forms a closed system with the channel 62 and the pressure compensation chamber 68.

1. Pressure wave massager for body parts, in particular erogenous zones such as a clitoris, comprising:
a pressure field-generating device with a cavity having an output cross-sectional area to be applied to a body part to be stimulated,
a medium-influencing assembly that acts upon a gaseous or liquid medium or a mixture thereof located in the cavity which is designed to generate in the cavity a pressure field of alternating negative pressures and positive pressures relative to a reference pressure:
a drive device, which is designed to drive the medium-influencing assembly in such a way that in the cavity the pressure field is created; and
a housing that jointly contains the drive device and the pressure field-generating device together with the medium-influencing assembly and at least a section of the cavity,
wherein a flexible wall section that covers the output cross-sectional area and thus closes off the cavity and that, when the pressure field is generated in the cavity, is set into a reciprocal motion for mechanical impact on the body part to be stimulated.

2. The pressure wave massage device according to claim 1, wherein the flexible wall section has, in an absence of the pressure field, a neutral position and when the pressure field is generated in the cavity into a reciprocal movement inward and outward around the neutral position relative to the cavity.

3. The pressure wave massager according to claim 1, wherein the flexible wall section is elastic and preferably pre-tensioned in a flat position in a style of a tensioned membrane.

4. The pressure wave massager according to claim 1, wherein the flexible wall section is formed in a style of a membrane that closes off the cavity or as such a membrane.

5. The pressure wave massager according to claim 1, wherein the output cross-sectional area and/or the flexible wall section has a substantially round shape.

6. The pressure wave massager according to claim 1, wherein the flexible wall section uses flexible material.

7. The pressure wave massage device according to claim 6, wherein the flexible material is a silicone material, in particular medical grade, or a thermoplastic elastomer or thermoplastic polyurethane.

8. The pressure wave massage device according to claim 6, wherein the flexible material has a Shore hardness in a range of Shore 5 to Shore 50.

9. The pressure wave massager according to claim 1, wherein a wall thickness of the flexible wall section is not less than 0.2 mm, in particular not less than 0.4 mm, preferably not less than 0.6 mm, and/or not greater than 2 mm, in particular not greater than 1 mm, preferably not greater than 0.8 mm.

10. The pressure wave massager according to claim 1, wherein a ratio between a diameter of the output cross-sectional area and a wall thickness of the flexible wall section covering the output cross-sectional area is not less than 5, in particular not less than 10, preferably not less than 15, and/or not greater than 60, in particular not greater than 30, preferably not greater than 20.

11. The pressure wave massager according to claim 1, wherein the cavity has a first end and, opposite the first end and at a distance from the first end a second end and is bounded by a side wall that connects its two ends in particular an essentially rigid side wall, and the first end has the output cross-sectional area.

12. The pressure wave massage device according to claim 11, wherein the output cross-sectional area is aligned at an angle or essentially transverse to a defined axis between the first end and the second end of the cavity.

13. The pressure wave massager according to claim 1 wherein the medium-influencing assembly has a volume-adjustment element for changing a volume of the cavity.

14. The pressure wave massage device according to claim 13, wherein
the cavity is bounded by a wall,
a section of an otherwise essentially rigid wall of the cavity is movable,
the volume-adjustment element has this movable section of the wall of the cavity, and
the drive device is designed to set this movable section of the wall of the cavity into a reciprocal motion.

15. The pressure wave massager according to claim 12, characterized in that the wall is formed by the side wall and a movable section of the wall is arranged at the second end of the cavity and preferably the second end of the cavity has an opening that is covered and thereby closed off by the movable section of the wall.

16. The pressure wave massage device according to claim 15, wherein a volume-adjustment element has a piston positioned inside the cavity, which is arranged in a reciprocally movable manner, and the drive device is designed to set the piston into a reciprocal motion.

17. The pressure wave massage device according to claim 16, characterized in that the piston is reciprocally movable along a section of the cavity, whereby preferably a cross-section of the cavity defined transversely to its length is, at least along the length of that section, essentially unchanged or at least nearly the same, and the piston has a corresponding cross-section, whereby the cavity preferably has a shape of a tube at least along that section.

18. The pressure wave massager according to claim 1, wherein the cavity forms a single continuous chamber.

19. The pressure wave massager according to claim 11, wherein the cross-sectional area of the cavity at its first end is larger than the cross-sectional area at its second end.

20. The pressure wave massager according to claim 13, wherein the cavity has a first chamber a second chamber having the output cross-sectional area and a connecting element connecting the first chamber to the second chamber, whereby the medium-influencing assembly is designed in such a way that it acts upon the first chamber.

21. The pressure wave massager according to claim 1, wherein the reference pressure is an ambient air pressure.

22. The pressure wave massager according to claim 1, wherein the device is a handheld device, preferably electrically powered by a battery.

23. The pressure wave massager according to claim 1, wherein a removable and/or interchangeable applicator body arranged on or in the housing, which contains a recess that forms at least a section of the cavity in the area of the cavity in the area of its output cross-sectional area.

24. The pressure wave massage device according to claim 23, wherein the recess is designed as an aperture.

25. The pressure wave massage device according to claim 24, wherein the applicator body is designed as a grommet.

26. Pressure wave massager according to claim 23, wherein the applicator body is of an essentially flexible material, in particular silicone.

27. The pressure wave massager according to claim 11, wherein the output cross-sectional area is aligned at an angle or essentially transverse to a defined axis between the first end and the second end of the cavity, and wherein the flexible wall section covering the cross-sectional area has no fixed connection to the side wall.

28. The pressure wave massage device according to claim 23, wherein at least one section of the cavity is comprehensively bounded by a side wall, in particular a rigid side wall, of a sleeve, preferably made of a plastic, forming the applicator body, which is connected to the housing, in particular by an elastically latching form closure, and the output cross-sectional area with the flexible wall section covering it, which is preferably formed in one piece and integral with the side wall.

29. The pressure wave massage device according to claim 28, wherein a wall thickness of the side wall is at least twice as thick as the wall thickness of the flexible wall section, preferably at least five times as thick.

30. The pressure wave massage device according to claim 28, wherein the sleeve is formed with the side wall and the flexible wall as a one-piece molded part in an injection molding process.

31. The pressure wave massager according to claim 1, wherein the cavity is closed off.

32. The pressure wave massager according to claim 1, wherein a compensation device for filling and emptying the cavity with a compressible or incompressible fluid or a mix thereof in a specific mixing ratio, whereby the compensation device preferably has a sealable channel that flows into the cavity and which is connected to a filling opening or a pressure equalization chamber.

33. An applicator body for a pressure wave massager according to claim 1, wherein the applicator body can be arranged on or in the housing of the pressure wave massager such that it can be detached and contains a recess for receiving a gaseous or liquid medium or a mixture thereof with a output cross-sectional area for application on a body part to be stimulated, wherein
a flexible wall section that covers the output cross-sectional area and thus closes off the recess and which, when a pressure field is generated, alternating between negative pressures and positive pressures relative to a reference pressure in the medium located in the recess, is set into a reciprocal motion for mechanical impact on the body part to be stimulated.

34. The applicator body according to claim 33, wherein the removable and/or interchangeable applicator body arranged on or in the housing, which contains a recess that forms at least a section of the cavity in the area of the cavity in the area of its output cross-sectional area, and wherein at least one section of the cavity is comprehensively bounded by a side wall, in particular a rigid side wall, of a sleeve, preferably made of a plastic, forming the applicator body, which is connected to the housing, in particular by an elastically latching form closure, and the output cross-sectional area with the flexible wall section covering it, which is preferably formed in one piece and integral with the side wall.

35. The applicator body according to claim 33, wherein the flexible wall section has, in an absence of the pressure field, a neutral position and when the pressure field is generated in the cavity into a reciprocal movement inward and outward around the neutral position relative to the cavity.

36. Modular system for constructing a pressure wave massager for stimulation of body parts, in particular erogenous zones such as a clitoris, comprising:
a pressure field-generating device which has a cavity with an output cross-sectional area for application on a body part to be stimulated and a medium-influencing assembly, located in the cavity which acts on a gaseous or liquid medium or a mixture thereof and which is designed so as to generate in the cavity a pressure field of alternating negative pressures and positive pressures relative to a reference pressure,
a drive device that is designed to drive the medium-influencing assembly in such a way that that the pressure field is generated in the cavity, and
a housing that jointly contains the drive device and the pressure field-generating device together with the medium-influencing assembly and with at least one section of the cavity,
located on or in the housing, a removable and/or interchangeable applicator body of a first kind, which contains a recess that forms at least a section of the cavity in the area of its output cross-sectional area, which is designed as an application opening, for indirect stimulation of body parts by means of pressure waves, wherein,
in place of the applicator body of the first kind, on or in the housing, a removable and/or interchangeable applicator body of a second kind, containing a recess forming at least a section of the cavity in the area of its output cross-sectional area, which is covered by a flexible wall section and thereby closed off, whereby the flexible wall section, when the pressure field is generated in the cavity, is set into a reciprocal motion for mechanical impact upon the body part to be stimulated for direct stimulation of that body part.

37. Modular system according to claim 36, wherein the medium-influencing assembly has a volume-adjustment element for changing a volume of the cavity. wave 21.

38. The modular system according to claim 36, wherein the removable and/or interchangeable applicator body of the first kind is arranged on or in the housing, which contains a recess that forms at least a section of the cavity in the area of the cavity in the area of its output cross-sectional area, and wherein at least one section of the cavity is comprehensively bounded by a side wall, in particular a rigid side wall, of a sleeve, preferably made of a plastic, forming the applicator body of the first kind, which is connected to the housing, in particular by an elastically latching form closure, and the output cross-sectional area with the flexible wall section covering it, which is preferably formed in one piece and integral with the side wall.

39. The modular system according to claim 36, wherein the flexible wall section of the applicator body of the second kind has, in an absence of the pressure field, a neutral position and when the pressure field is generated in the cavity into a reciprocal movement inward and outward around the neutral position relative to the cavity.

40. The modular system according to claim 36, wherein the cavity has a first end and, opposite the first end and at a distance from the first end, a second end and is bounded by a side wall that connects its two ends, in particular an essentially rigid side wall, and the first end has an output cross-sectional area.

41. Use of a pressure wave massage device originally intended for indirect stimulation of body parts, in particular erogenous zones such as a clitoris, by means of pressure waves comprising:
a pressure field-generating device which has a cavity with an application opening for applying to a body part to be stimulated and a medium-influencing assembly that acts upon a gaseous or liquid medium or a mixture thereof located in the cavity, which is designed so as to generate in the cavity a pressure field alternating between negative pressures and positive pressures relative to a reference pressure,
a drive device that is designed to drive the medium-influencing assembly in such a way that the pressure field is generated in the cavity and
a housing that jointly contains the drive device and the pressure field-generating device together with the medium-influencing assembly and with at least one section of the cavity,
wherein for direct stimulation of a body part to be stimulated, whereby the application opening is covered by a flexible wall section and thereby closed off, which, when the pressure field is generated in the cavity, is set into a reciprocal motion for mechanical impact upon the body part to be stimulated.

42. Use of the pressure wave massage device according to claim 41, wherein the flexible wall section has, in an absence of the pressure field, a neutral position and when the pressure field is generated in the cavity into a reciprocal movement inward and outward around the neutral position relative to the cavity.
